(19) United States
(12) Patent Application Publication
(10) Pub. No.: US 2025/0386392 A1
(43) Pub. Date: Dec. 18, 2025

(54) NON-TERRESTRIAL NETWORK UTILIZATION DURING TIME OF FLIGHT INTERFERENCE

(71) Applicant: T-MOBILE INNOVATIONS LLC, Overland Park, KS (US)

(72) Inventor: Gaviphat LEKUTAI, Kirkland, WA (US)

(21) Appl. No.: 18/744,320

(22) Filed: Jun. 14, 2024

(51) Int. Cl. H04W 76/25; H04B 17/318; H04L 5/14; H04W 76/10; H04W 84/06

(52) U.S. Cl. CPC H04W 76/25; H04B 17/318; H04L 5/14; H04W 76/10; H04W 84/06

(57) ABSTRACT

Systems and methods for mitigating time of flight interference are provided. Based on a determination that time of flight interference may occur or is occurring at a victim base station, a node of a non-terrestrial network is identified. Based on the determination and the identification, a victim UE connects to the node of the non-terrestrial network. In aspects, the victim UE forms an uplink connection with the node of the non-terrestrial network while maintaining a downlink connection with the victim base station. In other aspects, the victim UE forms a complete connection with the node of the non-terrestrial network.

### SUMMARY

The present disclosure is directed to mitigating time of flight interference, substantially as shown and/or described in connection with at least one of the Figures, and as set forth more completely in the claims.

According to various aspects of the technology, systems and methods of mitigating time of flight interference are provided. Non-terrestrial networks will be increasingly integrated with conventional cellular telecommunication networks. In order to communicate with a wide range of user equipment (UE), it is most likely that nodes of non-terrestrial networks (e.g., satellites) will be deployed with hardware and software configurations that utilize existing cellular telecommunication frequency bands to communicate with UEs at or near the ground. Such integration, along with the resultant overlapping coverage areas, presents the opportunity to divert a portion of network traffic from a terrestrial network to a non-terrestrial network to reduce the effects of time of flight interference. In aspects, one or more computer processing components may determine time of flight interference may occur or is occurring at the victim base station, and may identify a node of a non-terrestrial network. A victim UE may establish a connection with the node of the non-terrestrial network. In some aspects, the victim UE may establish an uplink connection to the node of the non-terrestrial network while maintaining a downlink connection to the victim base station, and in other aspects, the victim UE may establish a complete connection to the node of the non-terrestrial network.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 illustrates an exemplary computing device for use with the present disclosure;

FIG. 2 illustrates a diagram of an exemplary environment in which implementations of the present disclosure may be employed;

FIG. 3 depicts a flow diagram of an exemplary method for mitigating time of flight interference, in accordance with embodiments described herein; and

FIG. 4 depicts a flow diagram of an exemplary method for mitigating time of flight interference, in accordance with embodiments described herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, the provision of telecommunication services is moving beyond the surface of the earth at increasing speed. Network operators, once exclusively operating terrestrial base stations, will begin to utilize non-terrestrial network systems (e.g., drones, satellites) to provide services to subscribers. Existing terrestrial base stations may experience time of flight interference, such as interference caused by tropospheric ducting, which impacts the ability of a UE to effectively communicate with a victim base station (e.g., a terrestrial base station impacted by time of flight interference). For example, a downlink signal from an aggressor base station positioned far from the victim base station may travel within a tropospheric duct and may be received by the victim base station, impacting a UE's ability to transmit uplink signals to the victim base station. Such time of flight interference may cause failures in communication, increased data latency, and potential disruptions in service for users. Systems and methods seeking to improve network performance for all subscribers in the event of time of flight interference, specifically by utilizing non-terrestrial networks, are valuable.

Conventionally, when a victim base station is experiencing time of flight interference caused by an aggressor base station, the network may deploy time of flight interference mitigation mechanisms. Such mechanisms may include notifying the aggressor base station that it is the cause of the time of flight interference and causing the aggressor base station to mute some of its downlink channels to avoid such interference. However, this solution may cause reduced performance at the aggressor base station due to the fewer downlink channels in operation. Other time of flight interference mitigation techniques may include instructing victim UEs impacted by the time of flight interference to connect to another nearby base station that is not experiencing the interference. For example, a victim UE connected to a victim 5G base station may be handed over to a nearby 4G base station using frequency division duplexing, which may effectively eliminate the time of flight interference. However, this solution may cause congestion at the nearby base station, reducing network performance for UEs at the aggressor base station. Conventional time of flight interference mitigation or resolution techniques often require careful planning, and this planning becomes increasingly complex when there are multiple instances of time of flight interference between numerous base stations.

In order to reduce time of flight interference at a victim base station, and in contrast to conventional solutions, the present disclosure is directed to diverting at least a portion of the victim base station traffic to one or more nodes of a non-terrestrial network to reduce or eliminate the effects of time of flight interference felt by UEs. Time of flight interference may be detected, and a node of a non-terrestrial network may be identified. One or more network components may cause a victim UE (i.e., a UE experiencing negative effects of time of flight interference at the victim base station) to connect to the one or more nodes of the non-terrestrial network, such as a satellite. In some aspects, the victim UE may execute uplink transmissions with the one or more nodes of the non-terrestrial network, while continuing to receive unaffected downlink transmissions from the victim base station. In other aspects, the victim UE may both execute uplink transmissions with the one or more nodes of the non-terrestrial network and receive downlink transmissions from the one or more nodes of the non-terrestrial network. By providing one or more nodes of a non-terrestrial network to receive transmissions from the victim UE, the impacts of time of flight interference experienced by UEs and the subscribers that employ them are reduced and overall network performance is improved.

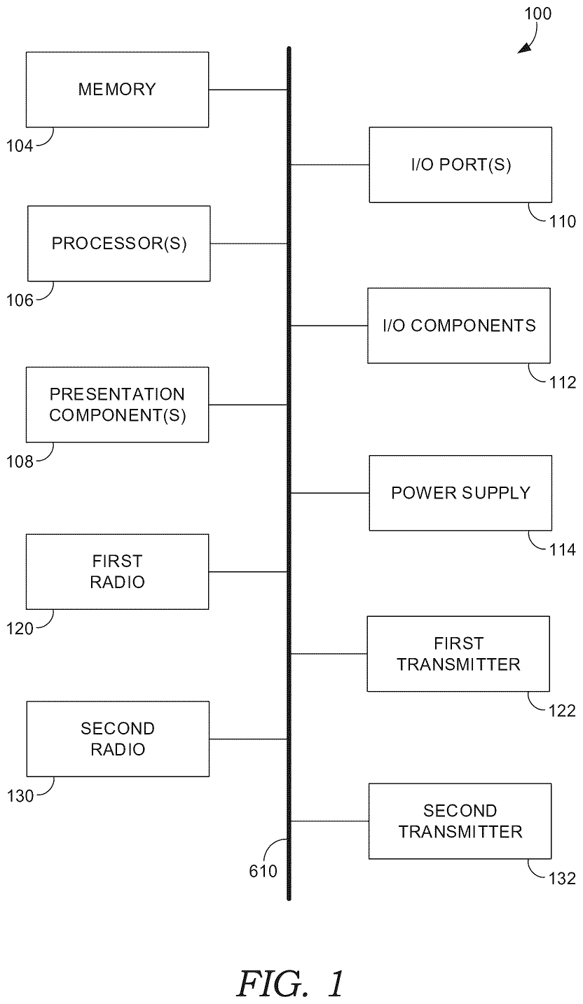

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment (UE), wireless communication device, or user device. The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104, or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

A first radio 120 and second radio 130 represent radios that facilitate communication with one or more wireless networks using one or more wireless links. In aspects, the first radio 120 utilizes a first transmitter 122 to communicate with a wireless network on a first wireless link and the second radio 130 utilizes the second transmitter 132 to communicate on a second wireless link. Though two radios are shown, it is expressly conceived that a computing device with a single radio (i.e., the first radio 120 or the second radio 130) could facilitate communication over one or more wireless links with one or more wireless networks via both the first transmitter 122 and the second transmitter 132. Illustrative wireless telecommunications technologies include CDMA, GPRS, TDMA, GSM, and the like. One or both of the first radio 120 and the second radio 130 may carry wireless communication functions or operations using any number of desirable wireless communication protocols, including 802.11 (Wi-Fi), WiMAX, LTE, 3G, 4G, LTE, 5G, 6G, NR, VOLTE, or other VoIP communications. In aspects, the first radio 120 and the second radio 130 may be configured to communicate using the same protocol but in other aspects they may be configured to communicate using different protocols. In some embodiments, including those that both radios or both wireless links are configured for communicating using the same protocol, the first radio 120 and the second radio 130 may be configured to communicate on distinct frequencies or frequency bands (e.g., as part of a carrier aggregation scheme). As can be appreciated, in various embodiments, each of the first radio 120 and the second radio 130 can be configured to support multiple technologies and/or multiple frequencies; for example, the first radio 120 may be configured to communicate with a base station according to a cellular communication protocol (e.g., 4G, 5G, 6G, or the like), and the second radio 130 may configured to communicate with one or more other computing devices according to a local area communication protocol (e.g., IEEE 802.11 series, Bluetooth, NFC, z-wave, or the like).

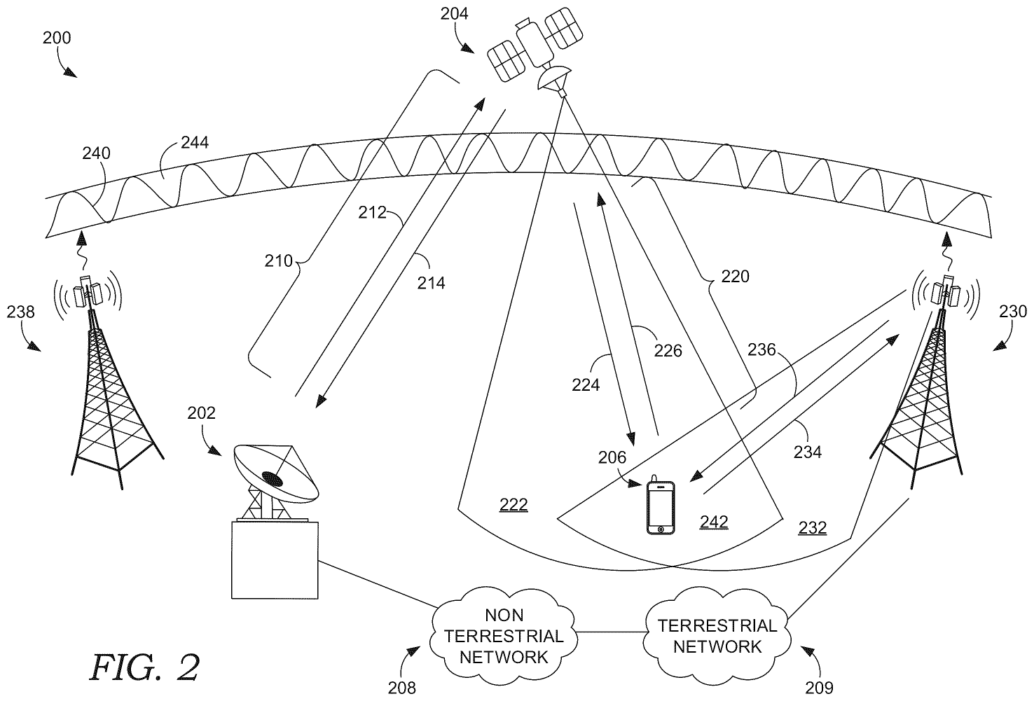

Turning now to FIG. 2, an exemplary network environment is illustrated in which implementations of the present disclosure may be employed. Such a network environment is illustrated and designated generally as network environment 200. At a high level the network environment 200 comprises a gateway 202, a non-terrestrial node 204 of a non-terrestrial network 208, one or more UEs (e.g., a UE 206), a victim base station 230 of a terrestrial network 209, and an aggressor base station 238 of the terrestrial network 209. Though the composition of network environment 200 illustrates some objects in the singular, it should be understood that more than one of each component is expressly conceived as being within the bounds of the present disclosure; for example, the network environment 200 may comprise multiple UEs, multiple gateways, multiple non-terrestrial nodes that communicate with a single gateway, and the like.

The network environment 200 includes one or more UEs, such as the UE 206. In aspects, the UE 206 is non-terrestrial network compatible UE. Though the UE 206 is illustrated as a cellular phone, a UE suitable for implementations with the present disclosure may be any computing device having any one or more aspects described with respect to FIG. 1.

The network environment 200 includes a gateway 202 communicatively connected to the non-terrestrial network 208 and the non-terrestrial node 204. The gateway 202 may be connected to the non-terrestrial network 208 via one or more wireless or wired connections and is connected to the non-terrestrial node 204 via a feeder link 210. The gateway 202 may take the form of a device or a system of components configured to communicate with the UE 206 via the non-terrestrial node 204 and to provide an interface between the non-terrestrial network 208 and the non-terrestrial node 204. Generally, the gateway 202 utilizes one or more antennas to transmit signals to the non-terrestrial node 204 via a forward uplink 212 and to receive signals from the non-terrestrial node 204 via a return downlink 214. The gateway 202 may communicate with a plurality of non-terrestrial nodes, including the non-terrestrial node 204.

The network environment 200 includes one or more non-terrestrial nodes, represented by non-terrestrial node 204. The non-terrestrial node 204 may take various forms (e.g., satellites, drones, aircrafts, high altitude platforms, and the like). The non-terrestrial node 204 is generally configured to relay communications between the gateway 202 and one or more UEs (e.g., the UE 206). The non-terrestrial node 204 communicates with the gateway 202 using the feeder link 210 and communicates with the UE 206 using a user link 220. The user link 220 comprises a forward downlink 224 used to communicate signals from the non-terrestrial node 204 to the UE 206 and a return uplink 226 used to communicate signals from the UE 206 to the non-terrestrial node 204. The non-terrestrial node 204 may communicate with the UE 206 using any wireless telecommunication protocol desired by a network operator, including but not limited to 3G, 4G, 5G, 6G, 802.11x and the like. Though shown as having a single beam providing coverage to a non-terrestrial coverage area 222, the non-terrestrial node 204 may be configured to utilize a plurality of individual beams to communicate with multiple different areas at or near the same time. Similarly, though a single forward downlink 224 and a single return uplink 226 are illustrated, the UE 206 may utilize multiple downlinks and/or multiple uplinks to communicate with the non-terrestrial node 204, using any one or more frequencies as desired by a network operator.

In some aspects, the non-terrestrial node 204 is a satellite having an orbit around the Earth. The orbit of any particular satellite will vary by operator desire and/or intended use. For example, a satellite suitable for use with the present disclosure may be characterized by its maximum orbital altitude and/or orbital period as Low Earth Orbit (LEO), Medium Earth Orbit (MEO), and High Earth Orbit (HEO). In such aspects, the orbit of the non-terrestrial node 204 may proceed such that the UE 206 is no longer within the non-terrestrial coverage area 222, but the UE 206 may now be within a coverage area of another non-terrestrial node of the non-terrestrial network 208. In such aspects, the UE 206 may be handed over from the non-terrestrial node 204 to the other non-terrestrial node to preserve the connection to the non-terrestrial network 208.

The network environment 200 includes one or more non-terrestrial networks, represented by the non-terrestrial network 208. The non-terrestrial network 208 comprises any one or more public or private networks. The non-terrestrial network 208 may be configured according to one or more network architectures and/or principles, such as conventional RAN, cloud-based RAN, and/or open RAN technologies. In some aspects, the non-terrestrial network 209 is a non-terrestrial core network. In some aspects, the non-terrestrial network 208 may be configured as a satellite network connecting to a plurality of gateways, such as the gateway 202. The UE 206 may communicate with the non-terrestrial network 208 via one or more non-terrestrial nodes, such as the non-terrestrial node 204. In aspects, the non-terrestrial network 208 utilizes a first frequency range to communicate with one or more UEs (e.g., the UE 206).

The network environment 200 includes one or more terrestrial, victim base stations, represented by the victim base station 230. The victim base station 230 is generally configured to relay communications between the terrestrial network 209 and one or more UEs (e.g., the UE 206). The victim base station 230 communicates signals to the UE 206 using a terrestrial downlink 234 and receives signals from the UE 206 using a terrestrial uplink 236. The victim base station 230 may communicate with the UE 206 using any wireless telecommunication protocol desired by a network operator, including but not limited to 3G, 4G, 5G, 6G, 802.11x and the like. Though shown as having a single beam providing coverage to a victim coverage area 232, the victim base station 230 may be configured to utilize a plurality of individual beams to communicate with multiple different areas at or near the same time. Similarly, though a single terrestrial downlink 234 and a single terrestrial uplink 236 are illustrated, the UE 206 may utilize multiple downlinks and/or multiple uplinks to communicate with the victim base station 230, using any one or more frequencies as desired by a mobile network operator.

The network environment 200 includes one or more terrestrial, aggressor base stations, represented by the aggressor base station 238. The aggressor base station 238 is generally configured to relay communications between the terrestrial network 209 and one or more UEs in a coverage area of the aggressor base station 238, as described with respect to the victim base station 230. The aggressor base station 238 may be located at a location geographically distant from the victim base station 230. As described below, the aggressor base station 238, while located far from the victim base station 230, may cause time of flight interference at the victim base station 230 and impact the ability of the victim base station 230 to communicate with one or more UEs (e.g., the UE 206).

The network environment 200 includes one or more terrestrial networks, represented by the terrestrial network 209. The terrestrial network 209 comprises any one or more public or private networks. The terrestrial network 209 may be configured according to one or more network architectures and/or principles, such as conventional RAN, cloud-based RAN, and/or open RAN technologies. The terrestrial network 209 may comprise a terrestrial core network. In some aspects, the terrestrial network 209 may comprise a cellular telecommunications network (e.g., a 4G, 5G, or 6G core network, an IMS network, and the like), a data network, and/or a publicly switched telephony network (PSTN). The UE 206 may communicate with the terrestrial network 209 via one or more terrestrial base stations, such as the victim base station 230. In aspects, the terrestrial network 209 utilizes a second frequency range to communicate with one or more UEs (e.g., the UE 206). In such aspects, the first frequency range of the non-terrestrial network 208 and the second frequency range of the terrestrial network 209 are different.

In aspects of the present disclosure, there may exist an overlapping coverage area 242, wherein the non-terrestrial coverage area 222 and the victim coverage area 232 at least partially overlap. The non-terrestrial coverage area 222 and the victim coverage area 232 may be determined to at least partially overlap where an edge of the non-terrestrial coverage area 222 is within a predetermined threshold distance of an edge of the victim coverage area 232. One or more UEs (e.g., the UE 206) may be located within the overlapping coverage area 242, such that the one or more UEs are located in both the non-terrestrial coverage area 222 and the victim coverage area 232. As such, the one or more UEs may connect to the victim base station 230 and/or the non-terrestrial node 204.

The victim base station 230 may occasionally or frequently experience time of flight interference, such as that caused by tropospheric ducting, resulting in an overall reduction in network performance for subscribers connected to the victim base station 230. Time of flight interference may involve timing discrepancies caused by varying travel times of transmitted and received signals, which can lead to overlapping time slots (at base stations configured to operate using time division duplexing (TDD)) and degraded communication performance. Tropospheric ducting may cause this time of flight interference by a distant base station (e.g., the aggressor base station 238) transmitting a downlink signal 240 that is carried to the victim base station 230 by a tropospheric duct 244. The tropospheric duct 244 may form when a temperature inversion is found in the troposphere, creating a duct of warm air surrounded above and below by cooler air, or the duct may be formed when there are layers of differing humidity in the troposphere. The downlink signal 240 from the aggressor base station 238 is carried through the tropospheric duct 244 further than intended, as the strength of the signal is maintained in the tropospheric duct 244. The victim base station 230, listening for UE uplink transmissions, may instead receive the downlink signal 240 from the aggressor base station 238. As a result, the uplink transmissions of the UE 206 are interfered and may not be received by the victim base station 230, causing delays in transmissions and reduced network performance. While time of flight interference may be caused by tropospheric ducting, time of flight interference may also be caused by other phenomena or occurrences (e.g., ionospheric scintillation, multipath propagation, refraction).

Relevant to the present disclosure, at least a portion of network traffic impacted by time of flight interference (e.g., interference caused by tropospheric ducting) may be diverted to the non-terrestrial network 208. Upon a determination that time of flight interference is occurring (or may occur) at the victim base station 230, one or more UEs in the overlapping coverage area 242 (e.g., the UE 206) may connect to the non-terrestrial node 204. In some aspects, the UE 206 may establish an uplink connection with the non-terrestrial node 204. In other aspects, the UE 206 may establish a complete connection with the non-terrestrial node 204 (e.g., the UE 206 receives downlink transmissions from the non-terrestrial node 204 and the non-terrestrial node 204 receives uplink transmissions from the UE 206).

In some aspects, one or more computer processing components determines time of flight interference is presently occurring at the victim base station 230. Whether time of flight interference is occurring may be determined based on time delay measurements (e.g., time of arrival (ToA), time difference of arrival (TDoA), round trip time (RTT)), error rates (e.g., bit error rate, frame error rate), a number of retransmissions from one or more UEs (e.g., the UE 206), spatial analysis (e.g., angle of arrival measurements), weather conditions (e.g., weather monitoring, topographic analysis), phase and frequency analysis (e.g., phase shift between signals, frequency responses), network performance measurements (e.g., signal to noise ratio (SNR), received signal strength indicator (RSSI), data latency, throughput rate), and the like. Determining the time of flight interference is occurring may be based on determining a tropospheric duct is within a threshold distance of the victim base station 230. For example, time of flight interference may be determined to be occurring when the victim base station 230 is within 10 miles of the tropospheric duct 244. Determining the time of flight interference is occurring may be based on determining the victim base station 230 operates using time division duplexing (TDD), which indicates the victim base station 230 is more susceptible to time of flight interference. In aspects, determining time of flight interference is occurring may include one or more of the considerations above. Determining the time of flight interference is occurring may be based on determining an interference over thermal (IOT) at the victim base station 230.

In other aspects, the one or more computer processing components may determine time of flight interference may occur at the victim base station 230 in the near future, allowing network operators to prospectively prevent the unwanted effects of time of flight interference. Whether time of flight interference may occur at the victim base station 230 may be based on historical data pertaining to any one or more considerations described with respect to determining time of flight interference is presently occurring at the victim base station 230. For example, predicted weather forecasts (e.g., a temperature inversion is predicted to occur at or within a threshold distance of the victim base station 230, humidity level variations are predicted to occur at or within a threshold distance of the victim base station 230) may assist in determining time of flight interference may occur at the victim base station 230. Further, determining whether time of flight interference may occur at the victim base station may include one or more of the location of the victim base station 230 (e.g., the victim base station 230 is within a threshold distance of a body of water), the season and/or time of the year (e.g., early spring, late spring, summer, winter, fall), historical interference patterns (e.g., time of occurrence, weather conditions at occurrence, duration of occurrence), mathematical models using such historical data, and the like.

The one or more computer processing components may identify the non-terrestrial node 204 of the non-terrestrial network 208. The non-terrestrial node 204 may be identified by one or more of spectrum monitoring (e.g., the victim base station 230 monitors radio frequencies being used nearby and identifies those associated with known satellite frequencies), signal monitoring (e.g., the victim base station 230 identifies a signal with unique non-terrestrial characteristics), coordination with non-terrestrial network operators (e.g., a satellite operator provides a network operator with ephemeris data and frequency plans of its satellites), geolocation techniques (e.g., the victim base station 230 determines the direction of the signal originates from overhead and indicates a satellite source), and/or accessing a database of known nodes (e.g., a database of known satellites and their associated signal characteristics and/or other identifying information). In some aspects, identifying the non-terrestrial node 204 may include determining the non-terrestrial node 204 operates using frequency division duplexing (FDD), which may reduce the likelihood of time of flight interference at the non-terrestrial node 204 or determining that the first frequency range used by the non-terrestrial node 204 is in a different band or sufficiently spaced apart from the second frequency range used by the victim base station 230.

Based on determining the time of flight interference is occurring (or may occur) and identifying the non-terrestrial node 204, one or more computer processing components may select a victim UE (e.g., the UE 206) to connect to the non-terrestrial node 204. In some aspects, the victim UE is selected at random, and in other aspects, the victim UE may be selected based on one or more considerations. The one or more considerations may include failed and/or degraded uplink transmissions to the victim base station 230, a throughput rate of the victim UE, a bit error rate of the victim UE, a signal interference ratio (SNR) of the victim UE, a distance between the victim UE and the victim base station 230 (e.g., the victim UE is located at the cell edge), a received signal strength indicator (RSSI) of the victim UE, and the like. The victim UE may be selected based on an interference over thermal (IOT) value of the victim base station 230. In some aspects, the victim UE is selected based on its SNR exceeding the IOT of the victim base station 230. The one or more considerations may include data latency, packet loss rate, signal strength fluctuations, reduced quality of service, and the like. In such examples, the victim UE may be selected based on the consideration exceeding a pre-determined threshold, or the victim UE may be selected based on extreme value selection, where the victim UE is selected based on having the most extreme value among other UEs in the victim coverage area 232 depending on the consideration being evaluated. In some aspects, the victim UE may be selected based on the victim UE being located within the victim coverage area 232. In such aspects, one or more computer processing components may select all UEs within the victim coverage area 232 and within the non-terrestrial coverage area 222 (e.g., the overlapping coverage area 242) to connect to one or more non-terrestrial nodes (e.g., the non-terrestrial node 204) within the non-terrestrial network 208.

Based on determining the time of flight interference is occurring (or may occur) and identifying the non-terrestrial node 204, the one or more computer processing components may cause the victim UE (e.g., the UE 206) to establish a connection with the non-terrestrial node 204. Causing the victim UE to establish a connection with the non-terrestrial node 204 may include the victim UE receiving a radio control channel (RRC) connection message requesting or instructing the UE alter or switch the spectrum of one or more of its transmitters (e.g., the first transmitter 122 and/or the second transmitter 132 of FIG. 1) and/or receivers to that of the non-terrestrial network 208. In some aspects, the victim UE establishes an uplink connection with the non-terrestrial node 204, while maintaining a downlink connection with the victim base station 230. Maintaining the downlink connection with the victim base station 230 may be beneficial where the interference at the victim base station 230 is caused by distant downlink transmissions from the aggressor base station 238, preventing the victim base station 230 from receiving uplink transmissions from the victim UE; however, the victim base station 230 may not experience interference in transmitting downlink signals to the victim UE. In other aspects, the victim UE establishes a complete connection with the non-terrestrial node 204. Establishing a complete connection with the non-terrestrial node 204 may be beneficial where both uplink transmissions and downlink transmissions are causing time of flight interference. In such aspects, the victim UE may disconnect from the victim base station 230 in favor of the connection to the non-terrestrial node 204.

In aspects where the victim UE (e.g., the UE 206) establishes the uplink connection with the non-terrestrial node 204 while maintaining the downlink connection with the victim base station 230, the victim UE may receive an RRC message requesting the victim UE change the spectrum of one or more of its transmitters (e.g., the first transmitter 122 and/or the second transmitter 132 of FIG. 1) to that of the non-terrestrial node 204, enabling the victim UE to transmit uplink connections to the non-terrestrial node 204. The victim UE may transmit uplink transmissions to the non-terrestrial node 204 and receive downlink transmissions from the victim base station 230. In such aspects, the non-terrestrial node 204 may receive requests or information from the victim in the form of the uplink transmissions. The non-terrestrial node 204 may communicate uplink information to the gateway 202, the gateway 202 may communicate the uplink information to the non-terrestrial network 208, the non-terrestrial network 208 may communicate the uplink information to the terrestrial network 209, and the terrestrial network 209 may communicate the uplink information to the victim base station 230. The victim base station 230 may use the uplink information to transmit a downlink transmission communicating a response or requested information to the victim UE.

In aspects where the victim UE (e.g., the UE 206) establishes a complete connection with the non-terrestrial node 204, the victim UE may both transmit uplink transmissions to the non-terrestrial node 204 and receive downlink transmissions from the non-terrestrial node 204. In some aspects, the UE 206 disconnects from the victim base station 230 in favor of the non-terrestrial connection. In some aspects, the victim UE receives an RRC connection message requesting the UE alter or switch the spectrum of one or more of each of its transmitters (e.g., the first transmitter 122 and/or the second transmitter 132 of FIG. 1) and receivers from that of the terrestrial network 209 to that of the non-terrestrial network 208, enabling the victim UE to connect to the non-terrestrial node 204 and reduce or avoid the effects of time of flight interference at the victim base station 230.

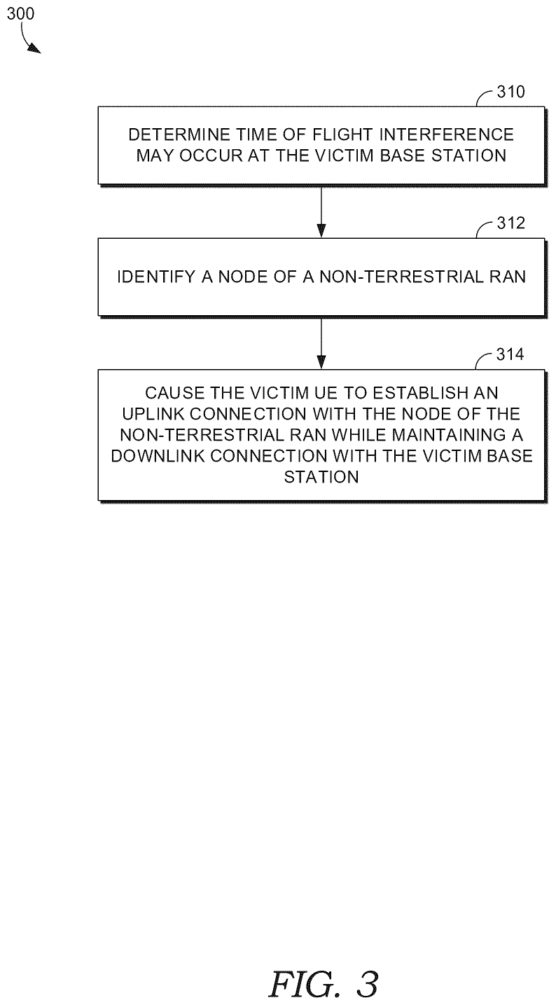

Turning now to FIG. 3, a flow chart representing a method 300 for mitigating time of flight interference is provided. The method 300 may be incorporated into a system having one or more of the components and/or features described with respect to FIG. 2. At a first step 310, one or more computer processing components determines time of flight interference may occur at the victim base station of a terrestrial radio access network (RAN) (e.g., the victim base station 230 of the terrestrial network 209 of FIG. 2). In some aspects, this may include determining time of flight interference is presently occurring at the victim base station. The victim base station of the terrestrial network may be configured to provide wireless coverage to a first coverage area (e.g., the victim coverage area 232 of FIG. 2). At a second step 312, the one or more computer processing components identify a node of a non-terrestrial network (e.g., the non-terrestrial node 204 of the non-terrestrial network 208). The node of the non-terrestrial network may be configured to provide wireless coverage to a second coverage area (e.g., the non-terrestrial coverage area 222 of FIG. 2). The victim UE is located in each of the first coverage area and the second coverage area (e.g., the overlapping coverage area 242 of FIG. 2). At a third step 314, the one or more computer processing components cause the victim UE to establish an uplink connection with the node of the non-terrestrial network while maintaining a downlink connection with the victim base station, according to any one or more aspects described with respect to FIG. 2. In aspects, the third step 314 occurs based on the determining in the first step 310 and the identifying in the second step 312.

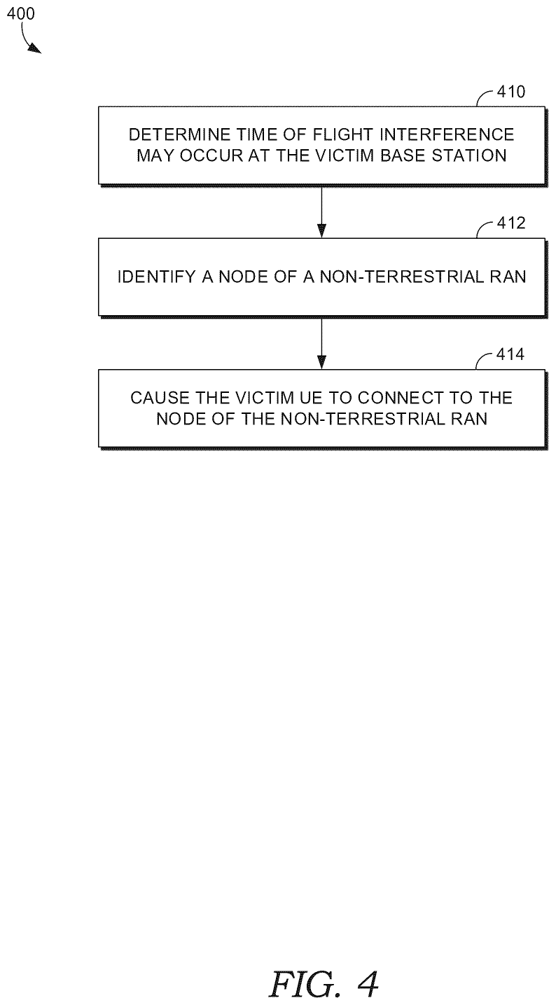

Turning now to FIG. 4, a flow chart representing a method 400 for mitigating time of flight interference is provided. The method 400 may be incorporated into a system having one or more of the components and/or features described with respect to FIGS. 2 and 3. In contrast to FIG. 3, the method 400 of FIG. 4 includes the victim UE establishing a complete connection (i.e., establishing both an uplink and downlink connection) to the node of the non-terrestrial network. At a first step 410, one or more computer processing components may determine a time of flight interference may occur at a victim base station of a terrestrial network (e.g., the victim base station 230 of the terrestrial network 209 of FIG. 2). In some aspects, this may include determining time of flight interference is occurring at the victim base station. The victim base station of the terrestrial network may be configured to provide wireless coverage to a first coverage area (e.g., the victim coverage area 232 of FIG. 2). At a second step 412, the one or more computer processing components identify a node of a non-terrestrial network (e.g., the non-terrestrial node 204 of the non-terrestrial network 208). The node of the non-terrestrial network may be configured to provide wireless coverage to a second coverage area (e.g., the non-terrestrial coverage area 222 of FIG. 2). The victim UE is located in each of the first coverage area and the second coverage area (e.g., the overlapping coverage area 242 of FIG. 2). At a third step 414, the one or more computer processing components may cause the victim UE to connect to the node of the non-terrestrial network, according to any one or more aspects described with respect to FIG. 2. The victim UE may communicate uplink transmissions to the node of the non-terrestrial network and the node of the non-terrestrial network may communicate downlink signals to the victim UE. In aspects, the third step 314 occurs based on the determining in the first step 310 and the identifying in the second step 312.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system for mitigating time of flight interference, the system comprising:
a victim base station of a terrestrial network configured to provide wireless coverage to a first coverage area; and
one or more computer processing components configured to perform operations comprising:
determine time of flight interference is occurring at the victim base station;
identify a node of a non-terrestrial network configured to provide wireless coverage to a second coverage area, wherein a victim UE is located in both of the first coverage area and the second coverage area; and
based on the determining and the identifying, cause the victim UE to establish an uplink connection with the node of the non-terrestrial network while maintaining a downlink connection to the victim base station.

2. The system of claim 1, wherein determining time of flight interference is occurring at the victim base station is based on determining a tropospheric duct is within a threshold distance of the victim base station.

3. The system of claim 2, wherein determining time of flight interference is occurring at the victim base station is based on determining the victim base station operates using time division duplexing (TDD).

4. The system of claim 3, wherein the victim UE is selected based on a degraded uplink transmission to the victim base station.

5. The system of claim 4, wherein identifying the node of the non-terrestrial network comprises determining the node operates using frequency division duplexing (FDD).

6. The system of claim 5, wherein the node of the non-terrestrial network comprises a satellite within a satellite network.

7. A system for mitigating time of flight interference, the system comprising:
a victim base station of a terrestrial network configured to provide wireless coverage to a first coverage area; and
one or more computer processing components configured to perform operations comprising:
determine time of flight interference may occur at the victim base station;
identify a node of a non-terrestrial network configured to provide wireless coverage to a second coverage area, wherein a victim UE is located in both of the first coverage area and the second coverage area; and
based on the determining and the identifying, cause the victim UE to establish an uplink connection the node of the non-terrestrial network while maintaining a downlink connection to the victim base station.

8. The system of claim 7, wherein determining time of flight interference may occur at the victim base station is based on determining a tropospheric duct may form within a threshold distance of the victim base station.

9. The system of claim 7, wherein determining time of flight interference may occur at the victim base station is based on determining the victim base station operates using time division duplexing (TDD).

10. The system of claim 7, wherein the victim UE is selected based on a failed uplink transmission to the victim base station.

11. The system of claim 7, wherein the victim UE is selected based on a bit error rate of the victim UE.

12. The system of claim 7, wherein the victim UE is selected based on a signal to interference ratio (SNR) of the victim UE.

13. The system of claim 12, wherein the victim UE is selected based on the SNR of the victim UE exceeding an interference over thermal (IOT) of the victim base station.

14. The system of claim 7, wherein identifying the node of the non-terrestrial network comprises determining the node operates using frequency division duplexing (FDD).

15. A system for mitigating time of flight interference, the system comprising:
a victim base station of a terrestrial network configured to provide wireless coverage to a first coverage area; and
one or more computer processing components configured to perform operations comprising:
determine time of flight interference may occur at the victim base station;
identify a node of a non-terrestrial network configured to provide wireless coverage to a second coverage area, wherein a victim UE is located within both of the first coverage area and the second coverage area; and
cause the victim UE to connect to the node of the non-terrestrial network.

16. The system of claim 15, wherein determining time of flight interference may occur at the victim base station is based on determining a tropospheric duct is within a threshold distance of the victim base station.

17. The system of claim 15, wherein the victim UE is selected based on a plurality of failed uplink transmissions to the victim base station.

18. The system of claim 15, wherein the victim UE is selected based on a bit error rate of the victim UE.

19. The system of claim 15, wherein the victim UE is selected based on a distance between the victim UE and the victim base station.

20. The system of claim 15, wherein the victim UE is selected based on a received signal strength indicator (RSSI) of the victim UE.
